(19) United States
(12) Patent Application Publication
(10) Pub. No.: US 2006/0079632 A1
(43) Pub. Date: Apr. 13, 2006

(54) Hybrid topcoats

(75) Inventors: Steffen Hofacker, Odenthal (DE); Markus Mechtel, Bergisch Gladbach (DE); Thomas Klimmasch, Leverkusen (DE)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/243,000

(22) Filed: Oct. 4, 2005

(30) Foreign Application Priority Data
Oct. 7, 2004 (DE) 102004048874.6

(51) Int. Cl. C08L 83/04; F21V 9/04

(52) U.S. Cl. 524/588; 252/588

(57) ABSTRACT

The present invention relates to weathering-stable mixtures for preparing organic-inorganic (hybrid) transparent topcoat materials. The hybrid composition comprises an inorganic binder based on polyfunctional organosilanes which contain at least 2 silicon atoms having in each case 1 to 3 alkoxy or hydroxyl groups, the silicon atoms being attached by in each case at least one Si—C bond to a structural unit that links the silicon unit; (semi)metal alkoxides and/or hydrolysis and concentration products of these; inorganic UV absorbers selected from the group consisting of ZnO and CeO₂; an organic polyol; and one or more solvents.

### FIELD OF THE INVENTION

This application claims priority to German application DE 10 2004 048 874, filed Oct. 7, 2004.

The present invention relates to weathering-stable mixtures for preparing organic-inorganic (hybrid) transparent topcoat materials. The mixture comprises polyfunctional organosilanes, (semi)metal alkoxides, inorganic UV absorbers, an organic polyol and one or more solvents.

### BACKGROUND OF THE INVENTION

Through the synthesis of organic-inorganic hybrid materials an attempt is made to combine typical properties of organic and inorganic substances in one material. For example, glasses are noted for their great hardness and acid resistance, whereas organic polymers constitute very elastic materials. Over time, a variety of organic-inorganic hybrid materials have become known, which on the one hand are much harder than pure organic polymers but yet do not exhibit the brittleness of purely inorganic materials.

According to the nature and manner of the interaction between organic and inorganic component, hybrid materials are classified into different types. An overview in relation to this is found in J. Mater. Chem. 6 (1996) 511.

One class of hybrid materials is obtained by the formation, through hydrolysis and condensation of (semi)metal alkoxy compounds, such as Si(OEt)₄, of an inorganic network which together with conventional organic polymers, such as polyesters or polyacrylates, constitutes a mixture whose polymer strands are mutually penetrative (interpenetrating network). Covalent chemical attachment of the one network to the other is not present; instead, interactions exist, if only weak (such as van der Waals or hydrogen bonds, for example). Hybrid materials of this kind are described for example in WO 93/01226 and WO 98/38251.

WO 98/38251 teaches that transparent hybrid materials are obtainable through mixtures of at least one organic polymer, inorganic particles, an inorganic-organic binder and solvents. Examples 8-10 describe mixtures which as a hybrid coating are distinguished, for example, by their hardness, optical transparency and crack-free application. As well as the properties described there, a property which is of particularly great importance in the field of topcoat finishing for the exterior sector is the outdoor weathering resistance, in other words the stability towards UV light acting in concert with climatic conditions. This property is not satisfactorily achieved by the systems described in WO 98/38251.

Thus in the sector of automotive topcoat finishing it is of great interest to protect, by means of a topcoat, the underlying, colour-bearing basecoat against effects of weathering and UV light and so to make it durable for many years. In years gone by numerous topcoat systems have been developed for this purpose, based for example on polyurethane chemistry, which fulfil this function and are additionally distinguished by high gloss. Owing to the purely organic structure of these coating systems, however, they exhibit disadvantages in the area of the simultaneous improvement of scratch resistance and acid resistance in such polyurethane systems. Thus it is found, for example, that by increasing the network density through an appropriate choice of the isocyanate component and of the hydroxyl component it is possible to achieve an improvement in acid resistance but, on the other hand, the system exhibits a brittleness that leads to the loss of scratch resistance properties. Conversely, a reduction in the network density as a result of greater elasticity leads to an improvement in the scratch resistance but, on the other hand, to a substantial drop in the acid resistance [MO Lackiertechnik, Vol. 54 (2000) 3].

The fundamental possibility of using cerium oxide particles as inorganic UV absorbers in inorganic-organic hybrid materials is described in EP-A 465 918. The disclosure content, however, says nothing about the extent to which it is possible by this means to influence the weathering behaviour, particularly with regard to gloss performance and acid resistance. EP-A 465 918 is also silent on details concerning the sizes of the CeO₂ particles used.

It was an object of the present invention, then, starting out from the systems described in WO 98/38251, to provide compositions for preparing organic-inorganic hybrid coatings which exhibit improved weathering properties, particularly with regard to UV stability, gloss performance and acid resistance.

### SUMMARY OF THE INVENTION

It has now been found that colour-free, transparent coatings having the requisite properties are obtained specifically when mixtures of organic and inorganic polymers are used that comprise, as inorganic particles, inorganic UV absorbers selected from the group consisting of ZnO and CeO₂, at least 90% of all of the particles of this kind that are used having an average particle size of ≦50 nm.

The average particle size in this context is determined by means of ultracentrifuge measurements in accordance with H. G. Müller, Colloid. Polym. Sci., 267 1113-1116 (1989).

The present invention accordingly provides hybrid compositions comprising
A) an inorganic binder based on polyfunctional organosilanes which contain at least 2 silicon atoms having in each case 1 to 3 alkoxy or hydroxyl groups, the silicon atoms being attached by in each case at least one Si—C bond to a structural unit that links the silicon unit,
B) (semi)metal alkoxides and their hydrolysis products and concentration products,
C) inorganic UV absorbers selected from the group consisting of ZnO and CeO₂ in the form of particles at least 90% of which have an average particle diameter as measured by ultracentrifuge of ≦50 nm,
D) an organic polyol having a hydroxyl functionality ≧2 and a number-average molecular weight of 250 g/mol to 10 000 g/mol, and
E) one or more solvents.

### DETAILED DESCRIPTION OF PREFERRED EMBODIMENTS

As used herein, as used in the examples or unless otherwise expressly specified, all numbers may be read as if prefaced by the word “about”, even if the term does not expressly appear. Also, any numerical range recited herein is intended to include all sub-ranges subsumed therein.

Inorganic binders of component A) are polyfunctional organosilanes which contain at least 2, preferably at least 3, silicon atoms having in each case 1 to 3 alkoxy or hydroxyl groups, the silicon atoms being attached by in each case at least one Si—C bond to a structural unit that links the silicon atoms.

As linking structural units for the purposes of the invention mention may be made by way of example of linear or branched C₁ to C₁₀ alkylene chains, C₅ to C₁₀ cycloalkylene radicals, aromatic radicals, e.g. phenyl, naphthyl or biphenylyl, or else combinations of aromatic and aliphatic radicals. The aliphatic and aromatic radicals may also contain heteroatoms, such as Si, N, O, S or F.

Examples of polyfunctional organosilanes are compounds of the general formula (I)
R¹₄₋ᵢSi[(CH₂)ₙSi(OR²)ₐR³₃₋ₐ]i (I)
where
i=2 to 4, preferably i=4
n=1 to 10, preferably n=2 to 4, more preferably n=2
R¹=C₁-C₂₀-alkyl or C₆-C₂₀-aryl
R²=C₁-C₂₀-alkyl or C₆-C₂₀-aryl
preferably R²=methyl, ethyl, isopropyl
R³=C₁-C₂₀-alkyl or C₆-C₂₀-aryl
preferably R³=methyl
a=1 to 3, and if a=1 R² can also be hydrogen.

Further examples of polyfunctional organosilanes are cyclic compounds of the general formula (II) 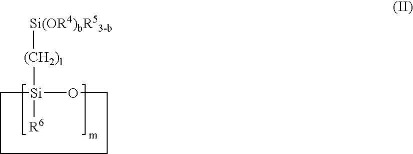
where
m=3 to 6, preferably m=3 or 4
l=2 to 10, preferably l=2
R⁴=C₁-C₂₀-alkyl or C₆-C₂₀-aryl
preferably R⁴=methyl, ethyl, isopropyl
R⁵=C₁-C₂₀-alkyl or C₆-C₂₀-aryl
preferably R⁵=methyl
R⁶=C₁-C₆ alkyl or C₆-C₁₄ aryl, preferably R⁶=methyl, ethyl, more preferably R⁶=methyl
b=1 to 3, and if b=1 R⁴ can also be hydrogen.

Further examples of polyfunctional organosilanes are compounds of the general formula (III)
Si[OSiR⁷₂(CH₂)ₚSi(OR⁸)_{c}R⁹_{3-c}]₄ (III)
where
p=1 to 10, preferably p=2 to 4, more preferably p=2
R⁷=C₁-C₂₀-alkyl or C₆-C₂₀-aryl
preferably R⁷=methyl
R⁸=C₁-C₂₀-alkyl or C₆-C₂₀-aryl
preferably R⁸=methyl, ethyl, isopropyl
R⁹=C₁-C₂₀-alkyl or C₆-C₂₀-aryl
preferably R⁹=methyl
c=1 to 3, and if c=1 R⁸ can also be hydrogen.

Additionally mention may be made as polyfunctional organosilanes of silanols or alkoxides; for example:
a.) Si[(CH₂)₂Si(OH)(CH₃)₂]₄
b.) cyclo-{OSiMe[(CH₂)₂Si(OH)Me₂]}₄
c.) cyclo-{OSiMe[(CH₂)₂Si(OEt)₂Me]}₄
d.) cyclo-{OSiMe[(CH₂)₂Si(OMe)Me₂]}₄
e.) cyclo-{OSiMe[(CH₂)₂Si(OEt)₃]}_{4.}

Likewise possible for use are the oligomers, i.e. the hydrolysis products and condensation products of the aforementioned compounds and of compounds of the formulae (I), (II) and/or (III).

With particular preference the inorganic binders of component (A) are based on cyclo-{OSiMe[(CH₂)₂Si(OH)Me₂]}₄ and/or cyclo-{OSiMe[(CH₂)₂Si(OEt)₂Me]}.

The (semi)metal alkoxides of component B) are described by the general formula (IV)
R¹⁰_{x-y}M(OR¹¹)_{y} (IV)
where
M=Si, Sn, Ti, Zr (x=4, y=1 to 4) or
M=B, Al(x=3, y=1 to 3),
R¹⁰, R¹¹=C₁-C₂₀-alkyl or C₆-C₂₀-aryl
preferably R¹⁰, R¹¹=methyl, ethyl, isopropyl, n-butyl, sec-butyl, tert-butyl, phenyl,
more preferably R¹⁰, R¹¹=methyl and ethyl.

Examples are Si(OEt)₄, Si(OMe)₄, H₃C—Si(OEt)₃, H₃C—Si(OMe)₃, B(OEt)₃, Al(OⁱPr)₃, or Zr(OⁱPr)₄. In the sense of the invention it is also possible, rather than the monomeric alkoxides, to use their hydrolysis products and condensation products. Available commercially are, for example, Si(OEt)₄ condensates. Particular preference is given to using in component B) Si(OEt)₄ and its hydrolysis products and/or condensation products.

The inorganic UV absorbers of component C) preferably have an average particle size of ≦30 nm.

Preferably at least 98%, more preferably at least 99.5%, of all of the particles used have the requisite average particle size.

These inorganic UV absorbers can be used as they are but preferably in the form of dispersions (sols). Solvents used in this case can be not only water, aqueous acids or bases but also organic solvents or mixtures thereof.

Particular preference is given to using in C) dispersions (sols) of ZnO and/or CeO₂, very preferably acid-stabilized dispersions (sols) of CeO₂ of the abovementioned size ranges.

Organic polyols D) are those having a hydroxyl functionality ≧2 and a number-average molecular weight of preferably 500 g/mol to 5000 g/mol. Preference is given here to using commercially customary hydroxyl-functional polymers, based for example on polyesters, polycarbonates, polyacrylates or polymethacrylates, and also mixtures and/or copolymers thereof.

As solvents E) mention may be made by way of example of the following: alcohols, such as methanol, ethanol, isopropanol, 2-butanol, 1,2-ethanediol or glycerol, ketones, such as acetone, methyl ethyl ketone, methyl isobutyl ketone or butanone, esters, such as ethyl acetate or methoxypropyl acetate, aromatics, such as toluene or xylene, ethers, such as tert-butyl methyl ether, and aliphatic hydrocarbons. It is preferred to use polar solvents and more preferred to use alcohols. It is of course also possible to use mixtures of different solvents. Employed with preference are solvent mixtures having alcohol and/or ester fractions of more than 50% by weight, more preferably of more than 80% by weight.

The amount of the solvent E) is preferably chosen such that the solids content of the composition is 5% to 75% by weight, more preferably 25% to 55% by weight.

The compositions of the invention may further comprise catalysts which serve to accelerate the hydrolysis and condensation reactions. Catalysts which can be used include organic and inorganic acids and bases and also organometallic compounds, fluoride compounds or else metal alkoxides. Examples that may be mentioned include the following: acetic acid, p-toluenesulphonic acid, hydrochloric acid, sulphuric acid, ammonia, dibutylamine, potassium hydroxide, sodium hydroxide, ammonium fluoride, sodium fluoride, or aluminium isopropoxide.

In one preferred embodiment of the invention the compositions of the invention comprise, disregarding the solvents E),
1% to 20% by weight of inorganic binder A),
25% to 80% by weight of (semi)metal alkoxides B),
0.1% to 20% by weight of inorganic UV absorbers C) and
10% to 60% by weight of organic polyol D),
the constituents A) to D) adding up to 100% by weight.

In one particularly preferred embodiment of the invention these compositions comprise
5% to 15% by weight of inorganic binder A),
40% to 65% by weight of (semi)metal alkoxides B),
0.2% to 10% by weight of inorganic UV absorbers C) and
20% to 45% by weight of organic polyol D),
the constituents A) to D) adding up to 100% by weight.

The compositions of the invention are typically prepared by first introducing components A) and B) and also, if desired, fractions of component E) and subsequently carrying out (partial) hydrolysis, by adding acid where appropriate, and finally adding C) and, if appropriate, further component E) with stirring and optionally with cooling. This is followed by the addition of component D).

The inorganic UV absorbers C) are therefore introduced into the composition a) of the invention preferably by stirred incorporation into the inventive component A) and/or B). Stirred incorporation into the organic polyol component which is later crosslinked by means of isocyanate groups is not preferred.

The present invention additionally provides coating materials at least comprising
a) one of the hybrid compositions of the invention described above and
b) a crosslinker which is reactive towards OH groups.

In b) it is preferred to use polyisocyanates and/or polyisocyanate mixtures.

Polyisocyanates or polyisocyanate mixtures of this kind comprise any desired polyisocyanates prepared by modifying simple aliphatic, cycloaliphatic, araliphatic and/or aromatic diisocyanates, synthesized from at least two diisocyanates and having a uretdione, isocyanurate, allophanate, biuret, iminooxadiazinedione and/or oxadiazinetrione structure, such as are described by way of example in, for example, J. Prakt. Chem. 336 (1994) 185-200 or the publications DE-A 16 70 666, 19 54 093, 24 14 413, 24 52 532, 26 41 380, 37 00 209, 39 00 053 and 39 28 503 or EP-A 336 205, 339 396 and 798 299.

Suitable diisocyanates for preparing such polyisocyanates are any desired diisocyanates obtainable through phosgenation or by phosgene-free methods, for example by thermal urethane cleavage, and from the molecular weight range 140 to 400, containing aliphatically, cycloaliphatically, araliphatically and/or aromatically attached isocyanate groups, such as 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl- 1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone-diisocyanate, IPDI), 4,4′-diisocyanatodicyclohexylmethane, 1-isocyanato-1-methyl-4(3)isocyanatomethylcyclohexane, bis(isocyanatomethyl)norbomane, 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane (MDI), 1,5-diisocyanatonaphthalene or any desired mixtures of such diisocyanates.

Preferably the polyisocyanates or polyisocyanate mixtures involved are those of the stated type containing exclusively aliphatically and/or cycloaliphatically attached isocyanate groups.

Very particular preference is given to polyisocyanates and polyisocyanate mixtures with an isocyanurate structure based on HDI, IPDI and/or 4,4′-diisocyanatodicyclohexylmethane.

Further it is also possible to use what are called blocked polyisocyanates and/or isocyanates, preferably blocked polyisocyanates or polyisocyanate mixtures, very preferably blocked polyisocyanates or polyisocyanate mixtures with an isocyanurate structure based on HDI, IPDI and/or 4,4′-diisocyanatodicyclohexylmethane.

The blocking of (poly)isocyanates for temporary protection of the isocyanate groups is a working method which has been known for a long time and is described for example in Houben Weyl, Methoden der organischen Chemie XIV/2, pp. 61-70.

Examples of suitable blocking agents include all compounds which when the blocked (poly)isocyanate is heated, optionally with the presence of a catalyst, can be eliminated. Examples of suitable blocking agents are sterically bulky amines such as dicyclohexylamine, diisopropylamine, N-tert-butyl-N-benzylamine, caprolactam, butanone oxime, imidazoles with the various possible substitution patterns, pyrazoles such as 3,5-dimethylpyrazole, triazoles and tetrazoles, and also alcohols such as isopropanol and ethanol. In addition the possibility also exists of blocking the isocyanate group in such a way that in the course of a further reaction the blocking agent is not eliminated but instead the intermediate formed is consumed by reaction. This is the case in particular with cyclopentanone-2-carboxyethyl ester, which in the course of the thermal crosslinking reaction is fully incorporated by reaction into the polymeric network and is not eliminated again.

As catalysts for the reaction of the compositions of the invention with the polyisocyanates it is possible to use catalysts such as commercially customary organometallic compounds of the elements aluminium, tin, zinc, titanium, manganese, iron, bismuth or else zirconium, such as dibutyltin laurate, zinc octoate and titanium tetraisopropoxide. Also suitable in addition, however, are tertiary amines such as 1,4-diazabicyclo[2.2.2]octane, for example.

A further possibility is to accelerate the reaction of the polyisocyanates from b) with the compositions of the invention from a) by carrying out the said reaction at temperatures between 20 and 200° C., preferably between 60 and 180° C., more preferably between 70 and 150° C.

The ratio of a) to b) is in this case made such as to result in an NCO/OH ratio of the free and optionally blocked NCO groups from b) to the OH groups of component D) from a) of 0.3 to 2, preferably 0.4 to 1.5, more preferably 0.5 to 1.0.

In blends with the auxiliaries that are customary in coating technology, such as organic or inorganic pigments, further organic light stabilizers, free-radical scavengers, paint additives, such as dispersants, flow control agents, thickeners, defoamers and other auxiliaries, tackifying agents, fungicides, bactericides, stabilizers or inhibitors, and further catalysts, it is possible, starting from the composition of the invention, particularly in the form of the coating materials of the invention, to prepare highly resistant paints for automotive construction.

The coating materials of the invention can also find application, furthermore, in the sectors of plastics coating, floor coating and/or wood/furniture coating.

### EXAMPLES

Unless noted otherwise all percentages are by weight.
cyclo-{OSiMe[(CH₂)₂Si(OEt)₂Me]}₄ (D4 diethoxide) was prepared as described in example 2 in WO 98/38251.

The scratch resistance tests on the coatings produced took place in accordance with DIN 55668. The solvents and acid resistances were examined visually with the following evaluation: “0” (unchanged) to “5” (markedly changed: e.g. blistering, detachment or dissolution, softening etc.).

### Preparation of an Inventive Composition

### Example 1

A 4 l multi-necked flask was charged with 204.7 g of D4 diethoxide, 1054.1 g of tetraethoxysilane, 309.7 g of ethanol, 929.2 g of 2-butanol and 103.3 g of butyl glycol, this initial charge was homogenized and then first 108.4 g of 0.1 molar hydrochloric acid were added with stirring. After a stirring time of 30 minutes a further 111.2 g of 0.1 molar hydrochloric acid were added with stirring, followed by stirring for 60 minutes. Thereafter 56.8 g of cerium dioxide particles (Cerium Colloidal 20%, Rhodia GmbH, Frankfurt/Main, Germany) were added with stirring, followed by 55.1 g of 2.5% strength acetic acid. After ageing for 24 hours, 1132.4 g of low boilers were stripped off in vacuo on a rotary evaporator at 80 mbar and a waterbath temperature of 40° C.

Finally 1593.0 g of the resulting mixture were mixed with 948.0 g of an acrylate polyol having a hydroxyl number of 93.5 mg KOHg (Desmophen® A 665 BA/X, Bayer MaterialScience AG, Leverkusen, Germany) and the mixture was homogenized.

The inventive mixture thus obtained has a theoretical hydroxyl number, based solely on the organic polyol component, of 29.6 mg KOH/g and a solids content of 39.9% by weight.

### Preparation of an Inventive Coating Material

### Example 2

83.2% by weight of a mixture obtained from example 1 was additized with

0.4% by weight of Baysilone® OL 17, 10% strength in xylene (Borchers GmbH, Langenfeld, Germany),

0.8% by weight of BYK®-070 (BYK-Chemie GmbH, Wesel, Germany),

0.4% by weight of tinuvin 123 (Ciba Spezialitätenchemie Lampertheim GmbH, Lampertheim, Germany),

0.6% by weight of tinuvin 384-2 (Ciba Spezialitätenchemie Lampertheim GmbH, Lampertheim, Germany) and

5.8% by weight of a 1:1 mixture of 1-methoxypropyl acetate and solvent naphtha 100 (Kraemer&Martin GmbH, St. Augustin, Germany).

Thereafter 8.8% by weight of a blocked polyisocyanate based on an HDI trimer (Desmodur® VPLS 2253, Bayer MaterialScience AG, Leverkusen, Germany) was added and the coating solution obtained was applied immediately thereafter by spraying to a metal panel coated with conventional basecoat material. After an evaporation time of about 10 minutes at room temperature the system was dried at 140° C. for 30 minutes. This gave a transparent coating with a film thickness of 40 to 60 μm.

### Example 3

88.4% by weight of a mixture obtained from example 1 was additized with

0.4% by weight of Baysilone® OL 17, 10% strength in xylene (Borchers GmbH, Langenfeld, Germany),

0.8% by weight of BYK®-070 (BYK-Chemie GmbH, Wesel, Germany),

0.4% by weight of tinuvin 123 (Ciba Spezialitätenchemie Lampertheim GmbH, Lampertheim, Germany),

0.6% by weight of tinuvin 384-2 (Ciba Spezialitätenchemie Lampertheim GmbH, Lampertheim, Germany) and

4.3% by weight of a 1:1 mixture of 1-methoxypropyl acetate and solvent naphtha 100 (Kraemer&Martin GmbH, St. Augustin, Germany).

Thereafter 5.1% by weight of a polyisocyanate based on an HDI trimer (Desmodur® N 3390, Bayer MaterialScience AG, Leverkusen, Germany) was added and the coating solution obtained was applied immediately thereafter by spraying to a metal panel coated with conventional basecoat material. After an evaporation time of about 10 minutes at room temperature the system was dried at 140° C. for 30 minutes. This gave a transparent coating with a film thickness of 40 to 60 μm.

### Comparative Example 1

1021.0 g of tetraethoxysilane and 250 g of ethanol were admixed with 87.5 g of 0.1 N p-toluenesulphonic acid and the mixture was stirred at room temperature for one hour. Subsequently 125 g of SiO₂ nanoparticle dispersion (Levasil® 200 S, HC Starck GmbH & Co. KG, Goslar, Germany) were adjusted to a pH of 2 using a few drops of concentrated sulphuric acid, dissolved in 50 g of ethanol and added slowly dropwise with stirring to the mixture obtained. After a further 15 minutes of stirring, 1000 g of 2-butanol were added and at an oil bath temperature of max. 110° C. 1210.0 g of low boilers were distilled off under atmospheric pressure. Subsequently the residue was weighed and made up with 2-butanol to 1328.0 g. The resulting hydrolysate was finally filtered. This gives a translucent solution.

581.1 g of the resulting hydrolysate were mixed with 252.1 g of an acrylate polyol (Desmophen® A 665 BA/X, Bayer MaterialScience AG, Leverkusen, Germany).

### Comparative example 2

81.5% by weight of a mixture obtained from comparative example 1 was additized with

0.4% by weight of Baysilone® OL 17, 10% strength in 1-methoxypropyl acetate (MPA) (Borchers GmbH, Langenfeld, Germany),

0.8% by weight of BYK®-070 (BYK-Chemie GmbH, Wesel, Germany),

0.4% by weight of tinuvin 123 (Ciba Spezialitätenchemie Lampertheim GmbH, Lampertheim, Germany) and

0.6% by weight of tinuvin 384-2 (Ciba Spezialitätenchemie Lampertheim GmbH, Lampertheim, Germany).

Thereafter 5.8% by weight of a blocked polyisocyanate based on an HDI trimer (Desmodur® VPLS 2253, Bayer MaterialScience AG, Leverkusen, Germany) was added and the mixture was stirred for 15 minutes and left to age at room temperature for 24 hours.

To prepare the coating solution the resulting mixture was admixed with stirring with 4.7% by weight of D4 diethoxide and 5.8% by weight of 0.1 N p-toluenesulphonic acid. After an ageing time of 2 hours the resulting coating solution was applied by spraying to a metal panel coated with conventional basecoat material. After an evaporation time of about 10 minutes at room temperature the system was dried at 140° C. for 30 minutes. This gave a transparent coating with a film thickness of 40 to 60 μm.

### Comparative example 3

54.3% by weight of an acrylate polyol (Desmophen® A 665 BA/X, Bayer MaterialScience AG, Leverkusen, Germany) was additized with

0.5% by weight of Baysilone® OL 17, 10% strength in 1-methoxypropyl acetate (MPA) (Borchers GmbH, Langenfeld, Germany),

0.5% by weight of Modaflow, 1% strength in methoxypropyl acetate (MPA) (Monsanto Co., St. Louis, USA),

1.1% by weight of Tinuvin 292, 50% strength in 1-methoxypropyl acetate (MPA) (Ciba Spezialitätenchemie Lampertheim GmbH, Lampertheim, Germany),

1.6% by weight of Tinuvin 384-2, 50% strength in 1-methoxypropyl acetate (MPA) (Ciba Spezialitätenchemie Lampertheim GmbH, Lampertheim, Germany), and

21.6% by weight of a 1:1 mixture of 1-methoxypropyl acetate and solvent naphtha 100 (Kraemer&Martin GmbH, St. Augustin, Germany).

Thereafter 20.4% by weight of a polyisocyanate based on an HDI trimer (Desmodur® N 3390, Bayer MaterialScience AG, Leverkusen, Germany) was added and the coating solution obtained was applied immediately thereafter by spraying to a metal panel coated with conventional basecoat material. After an evaporation time of about 10 minutes at room temperature the system was dried at 140° C. for 30 minutes. This gave a transparent coating with a film thickness of 40 to 60 μm.

### Comparative example 4

42.9% by weight of an acrylate polyol (Desmophen® A 665 BA/X, Bayer MaterialScience AG, Leverkusen, Germany) was additized with

0.5% by weight of Baysilone® OL 17, 10% strength in 1-methoxypropyl acetate (MPA) (Borchers GmbH, Langenfeld, Germany),

0.5% by weight of Modaflow, 1% strength in 1-methoxypropyl acetate (MPA) (Monsanto Co., St. Louis, USA),

1.0% by weight of Tinuvin 292, 50% strength in 1-methoxypropyl acetate (MPA) (Ciba Spezialitätenchemie Lampertheim GmbH, Lampertheim, Germany),

1.5% by weight of Tinuvin 384-2, 50% strength in 1-methoxypropyl acetate (MPA) (Ciba Spezialitätenchemie Lampertheim GmbH, Lampertheim, Germany),

2.5% by weight of dibutyltin dilaurate, 10% strength in 1-methoxypropyl acetate (MPA) and

21.0% by weight of a 1:1 mixture of 1-methoxypropyl acetate and solvent naphtha 100 (Kraemer&Martin GmbH, St. Augustin, Germany).

Thereafter 30.1% by weight of a blocked polyisocyanate based on an HDI trimer (Desmodur® VPLS 2253, Bayer MaterialScience AG, Leverkusen, Germany) was added and the coating solution obtained was applied immediately thereafter by spraying to a metal panel coated with conventional basecoat material. After an evaporation time of about 10 minutes at room temperature the system was dried at 140° C. for 30 minutes. This gave a transparent coating with a film thickness of 40 to 60 μm.

TABLE 1
Comparison of the paint technology properties

| | relative | acid | weathering |
|---|---|---|---|
| | residual gloss | resistance | stability |
| Example 2 | 86% | 52° C. | n.f.; >1000 h |
| Example 3 | 83% | 52° C. | n.f.; >1000 h |
| Comparative example 2 | n.d. | n.d. | cracks; 100 h |
| Comparative example 3 | 66% | 44° C. | n.f.; >1000 h |
| Comparative example 4 | 66% | 45° C. | n.f.; >1000 h |

n.d.: not determined
n.f.: nothing found

Relative Residual Gloss:

The relative residual gloss in % indicates how high the gloss (20°) is after scratching in accordance with DIN 5668 in comparison to the gloss prior to scratching. The higher this figure, the better the scratch resistance. The initial gloss prior to scratching was between 87% and 92% for all systems.

Acid Resistance:

The acid resistance is shown in ° C. units. To this end the coating is drizzled with 1% strength sulphuric acid and heated in a gradient oven. The temperature at which visible damage to the coating first occurs is shown in table 1. The higher this temperature, the more resistant the coating towards acid.

Weathering Stability:

The coatings were subjected to an accelerated weathering test (CAM 180 in accordance with VDA [German car-makers' association] 621-429). The coating failed when cracks, blisters, clouding or severe discoloration occurred. The time to failure and type thereof is shown in table 1.

As is apparent from table 1, the mixtures of the invention and the coatings obtained from them can be used to achieve significantly improved paint properties with regard to the simultaneous improvement of acid resistance and scratch resistance and also of weathering stability.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Hybrid compositions comprising
A) one or more inorganic binders based on polyfunctional organosilanes which contain at least 2 silicon atoms having in each case 1 to 3 alkoxy or hydroxyl groups, the silicon atoms being attached by in each case at least one Si—C bond to a structural unit that links the silicon unit,
B) (semi)metal alkoxides, hydrolysis products of (semi)metal alkoxides, condensation products of (semi)metal alkoxides, and combinations of these,
C) inorganic UV absorbers selected from the group consisting of ZnO, CeO₂ and combinations of ZnO and CeO₂ in the form of particles at least 90% of which have an average particle diameter as measured by ultracentrifuge of ≦50 nm,
D) one or more organic polyols having a hydroxyl functionality ≧2 and a number-average molecular weight of 250 g/mol to 10 000 g/mol, and
E) one or more solvents.

2. Hybrid compositions according to claim 1, wherein the inorganic binders in A) are based on cyclo-{OSiMe[(CH₂)₂Si(OH)Me₂]}₄ and/or cyclo-{OSiMe[(CH₂)₂Si(OEt)₂Me]}.

3. Hybrid compositions according to claim 1, wherein the (semi)metal alkoxides of component B) are monomeric Si(OEt)₄ or the hydrolysis products and/or condensation products of Si(OEt)₄.

4. Hybrid compositions according to one of claims 1, wherein in component C) CeO₂ particles are used at least 98% of which have an average particle size of ≦30 nm.

5. Hybrid compositions according to claim 1, wherein in the course of their preparation the inorganic UV absorbers are incorporated with stirring into one of components A) or B) before mixing with the organic polyol D) takes place.

6. Coating materials comprising
a. a hybrid composition according to claim 1 and
b. a crosslinker which is reactive towards OH groups.

7. Coating materials according to claim 6, wherein polyisocyanates or polyisocyanate mixtures are used as crosslinkers which are reactive towards OH groups.

8. Substrates coated with coatings obtainable using hybrid compositions according to claim 1.
